(19) United States
(12) Patent Application Publication
(10) Pub. No.: US 2014/0068218 A1
(43) Pub. Date: Mar. 6, 2014

(54) STORAGE DEVICE AND COMMUNICATION METHOD

(71) Applicant: Shinya IEMURA, Kanagawa (JP)

(72) Inventor: Shinya IEMURA, Kanagawa (JP)

(21) Appl. No.: 13/671,992

(22) Filed: Nov. 8, 2012

Related U.S. Application Data
(60) Provisional application No. 61/695,912, filed on Aug. 31, 2012.

(51) Int. Cl. G06F 12/00

(52) U.S. Cl. 711/167; 711/E12.001

(57) ABSTRACT

According to one embodiment, a storage device includes a queue, an interface unit, a selection unit and a delay unit. The interface unit exclusively executes command receiving processing of storing commands from a host in the queue and data transmission processing with the host. The selection unit selects one command from the commands stored in the queue. The delay unit delays a second timing at which data transmission processing for the selected command is started based on a first timing at which the command receiving processing is executed last. When a new command is not received between the first timing and the second timing, the interface unit starts the data transmission processing for the selected command at the second timing. When the new command is received between the first timing and the second timing, the interface unit executes command receiving processing for the new command.

### CROSS-REFERENCE TO RELATED APPLICATIONS

This application is based upon and claims the benefit of priority from U.S. Provisional Patent Application No. 61/695,912, filed on Aug. 31, 2012; the entire contents of which are incorporated herein by reference.

### FIELD

Embodiments described herein relate generally to a storage device and a communication method.

### BACKGROUND

One of connection standards of a storage device, such as an HDD (Hard Disk Drive) and the like, is a serial ATA (Serial Advanced Technology Attachment (SATA)) standard. According to the SATA standard, a function called NCQ (Native Command Queuing) is provided, which accumulates read/write commands from a host in a queue and arranges and executes (performs out-of-order execution of) the read/write commands accumulated in the queue in a row in order of efficiency.

### BRIEF DESCRIPTION OF THE DRAWINGS

FIG. 1 is a diagram illustrating an overview of a communication method according to Comparative Example.

FIG. 2 is a diagram illustrating an overview of a communication method of a first embodiment.

FIG. 3 is a diagram illustrating a configuration example of an SSD of the first embodiment.

FIG. 4 is a flowchart illustrating an operation of a device controller of the first embodiment.

FIG. 5 is a flowchart illustrating preparation processing.

FIG. 6 is a diagram illustrating a function of a CPU of a second embodiment.

FIG. 7 is a flowchart illustrating an operation of a timer setting value calculating unit of the second embodiment.

### DETAILED DESCRIPTION

In general, according to one embodiment, a storage device includes a queue, an interface unit, a selection unit and a delay unit. The interface unit exclusively executes command receiving processing of storing commands from a host in the queue and data transmission processing with the host. The selection unit selects one command from the commands stored in the queue. The delay unit delays a second timing at which data transmission processing for the selected command is started based on a first timing at which the command receiving processing is executed last. When a new command is not received between the first timing and the second timing, the interface unit starts the data transmission processing for the selected command at the second timing. When the new command is received between the first timing and the second timing, the interface unit executes command receiving processing for the new command.

Exemplary embodiments of a storage device and a communication method will be explained below in detail with reference to the accompanying drawings. The present invention is not limited to the following embodiments.

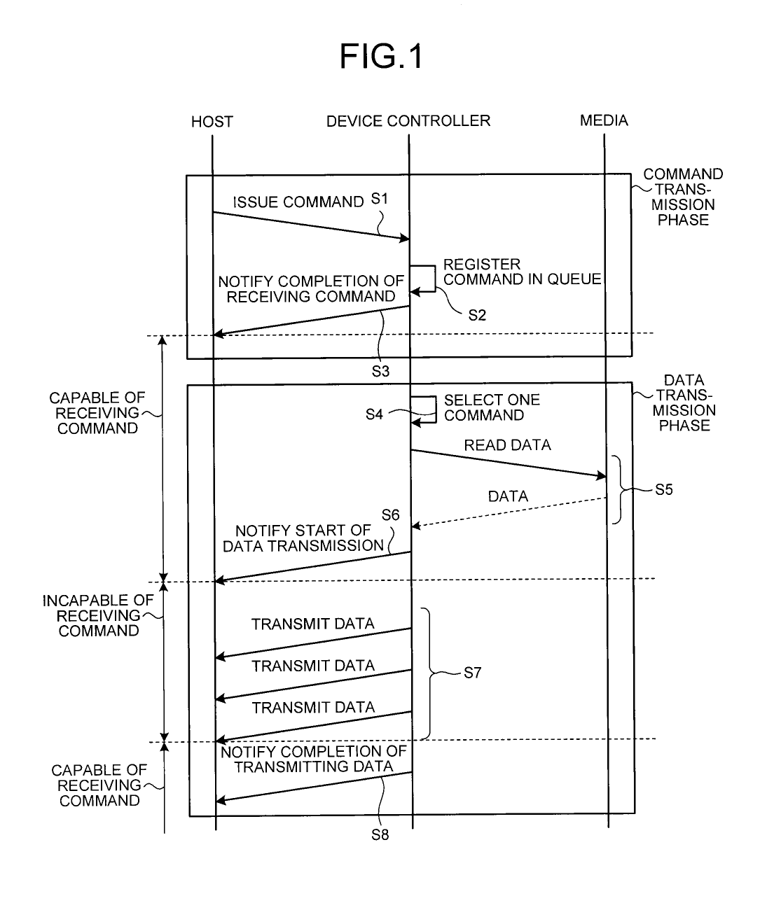

For helping understanding, first, a communication method compared with the embodiment of the present invention (hereinafter, just referred to as Comparative Example) will be described. FIG. 1 is a diagram describing an overview of a communication method according to Comparative Example between a host and a storage device. Note that, in this figure, the storage device is configured to include a media and a device controller controlling data transmission between the media and the host. A magnetic disk in the case of an HDD and a memory chip including a memory cell array in the case of an SSD (Solid State Drive) correspond to the media.

As illustrated in the figure, the host issues a command to the device controller (step S1). The command issued herein is a read command or a write command. The command includes a lead address of an access destination designated as LBA (Logical Block Addressing) and a data size designated as the number of sectors (sector count). Subsequent to processing of step S1, the device controller registers the command received from the host in a command queue (hereinafter, may also be referred to as the queue) (step S2). In addition, the device controller notifies the host of completion of receiving the command (step S3). Processing of steps S1 to S3 constitutes a command transmission phase (command receiving processing).

According to an NCQ function, the command transmission phase can be executed continuously at several times. When the command transmission phase is continuously executed, the commands which have been transmitted for each command transmission phase are accumulated in the queue of the device controller.

After the command transmission phase, the device controller selects one command from the commands stored in the queue (step S4). The device controller then executes preparation for executing the selected command (step S5). In the figure, a read command is configured to be selected in step S4. In the case of the read command, in the processing of step S5, the device controller accesses the media to read out data required by the read command to a cache memory from the media.

When the processing of step S5 is completed, the device controller can notify the host of the start of data transmission (step S6). In addition, the device controller distinguishes the data read out to the cache memory according to a predetermined size and transmits the distinguished data to the host (step S7). In addition, the device controller notifies the host of completion of transmitting the data (step S8). The processing of steps S4 to S8 constitutes a data transmission phase. Further, steps S6 to S8 constitute data transmission processing of the embodiment of the present invention.

Herein, the device controller can receive a next command until the notification processing (step S6) of the start of data transmission is completed even after the notification processing (step S3) of the completion of receiving the command is completed. When the next command is issued during the processing of steps S3 to S6, the command transmission phase is executed again, and as a result, the newly issued command is stored in the queue. However, when a period until the processing of step S6 is completed after the processing of step S3 is completed is smaller than an interval in which the host can continuously issue the command, a plurality of commands can not be accumulated in the queue. That is, an advantage of the NCQ function can not be taken.

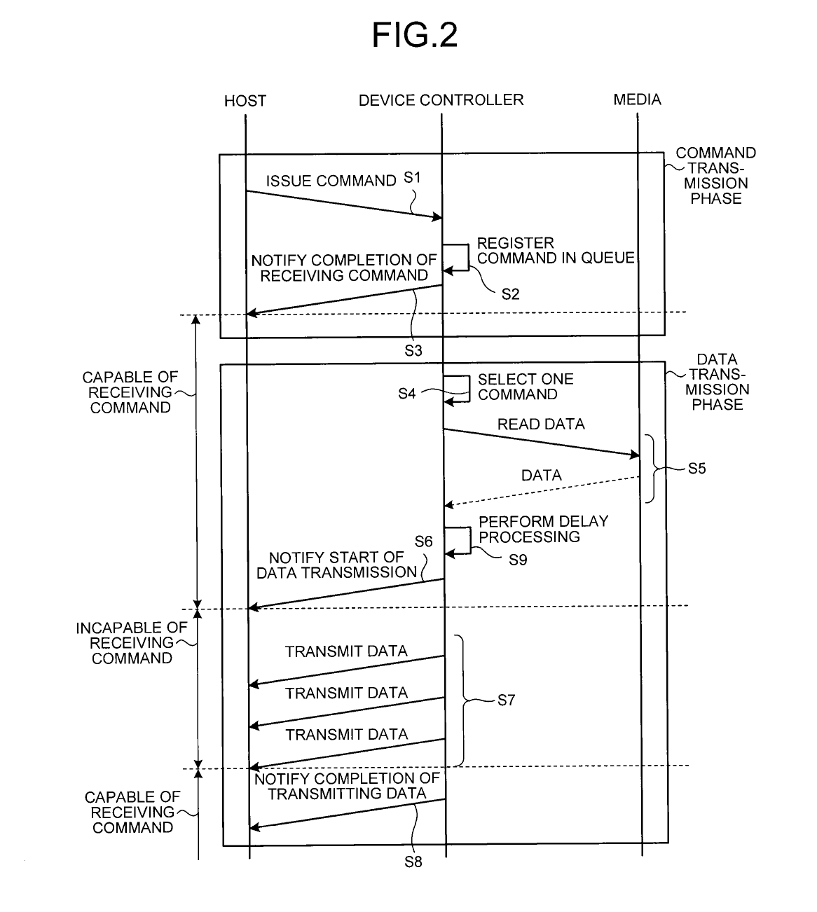

Therefore, according to the embodiment of the present invention, the device controller executes delay processing (step S9) between the processing of step S3 and the processing of step S6, as illustrated in FIG. 2. In other words, a second timing at which the data transmission processing according to the command selected by the processing of step S4 is started is delayed based on a first timing at which the command receiving processing has been most recently executed. As a result, since a period when a new command can be received after the most recent command receiving processing has been executed is extended, the continuous command transmission phase can be implemented by appropriately setting a delay time.

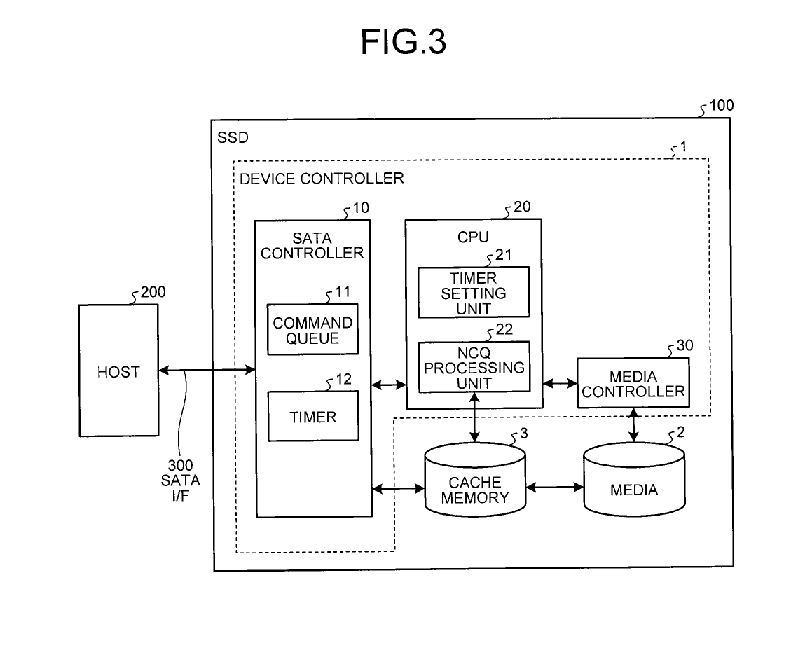

FIG. 3 is a diagram illustrating a configuration example of the storage device of the first embodiment of the present invention. Herein, an SSD adopting the storage device of the first embodiment will be described.

As illustrated in FIG. 3, an SSD 100 is connected to a host 200 via a SATA interface (I/F) 300. The SSD 100 serves as an external storage device of the host 200. For example, a personal computer corresponds to the host 200.

The SSD 100 includes a device controller 1, a media 2, and a cache memory 3. The media 2 is a memory chip mounted with a NAND type memory cell array. The cache memory 3 is a memory device which can be operated at a higher speed than the media 2 and used as a buffer of data transmission between the media 2 and the host 200. In the cache memory 3, for example, a DRAM (Dynamic Random Access Memory), a FeRAM (Ferroelectric Random Access Memory), an MRAM (Magnetoresistive Random Access Memory), and the like are adopted.

The device controller 1 includes a SATA controller (interface unit) 10, a CPU 20, and a media controller 30. The device controller 1 can be configured with a one-chip semiconductor device or a plural-chip semiconductor device. Further, the device controller 1 can be configured to include the cache memory 3.

The SATA controller 10 executes data transmission between the host 200 and the cache memory 3. The media controller 30 executes data transmission between the cache memory 3 and the media 2. The CPU 20 implements data transmission between the media 2 and the host 200 by controlling the SATA controller 10 and the media controller 30 based on a predetermined firmware program.

Further, the SATA controller 10 includes a command queue (queue) 11 accumulating and storing commands from the host 200 and a timer 12. The timer 12 serves as a delay unit of the embodiment of the present invention together with a timer setting unit 21 to be described below. The SATA controller 10 can execute the notification of the start of data transmission (step S6) while the timer 12 times out.

The CPU 20 includes the timer setting unit 21 and an NCQ processing unit (selecting unit) 22. The NCQ processing unit 22 determines an execution order of one or more commands stored in the queue 11. The timer setting unit 21 sets a value of the timer 12. In the first embodiment, the timer setting unit 21 sets a predetermined value in the timer 12 and starts the timer 12 after the notification of the completion of receiving the command (step S3) is completed. The value set in the timer 12 is previously determined by a designer so that the host 200 can continuously execute the command transmission phase. Since the notification of starting the data transmission (step S6) is started after the timer 12 times out, the delay processing (step S9) is interposed between the processing of step S3 and the processing of S6.

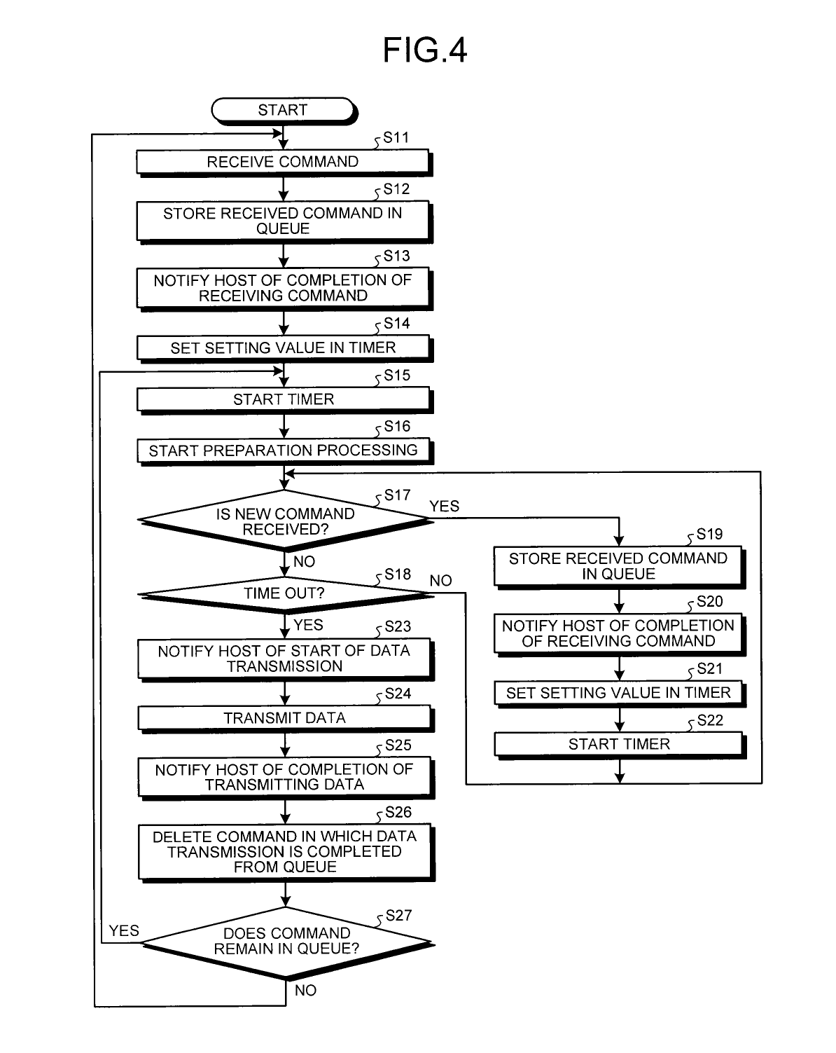

FIG. 4 is a flowchart illustrating an operation of the device controller 1 of the first embodiment.

The SATA controller 10 first receives the commands from the host 200 (step S11). Then, the SATA controller 10 stores the received commands in the queue 11 (step S12) and notifies the host 200 of the completion of receiving the command (step S13).

When the processing of step S13 is executed, the timer setting unit 21 sets a predetermined value in the timer 12 (step S14) to start the timer 12 (step S15). Further, the CPU 20 starts preparation processing for executing the command (step S16).

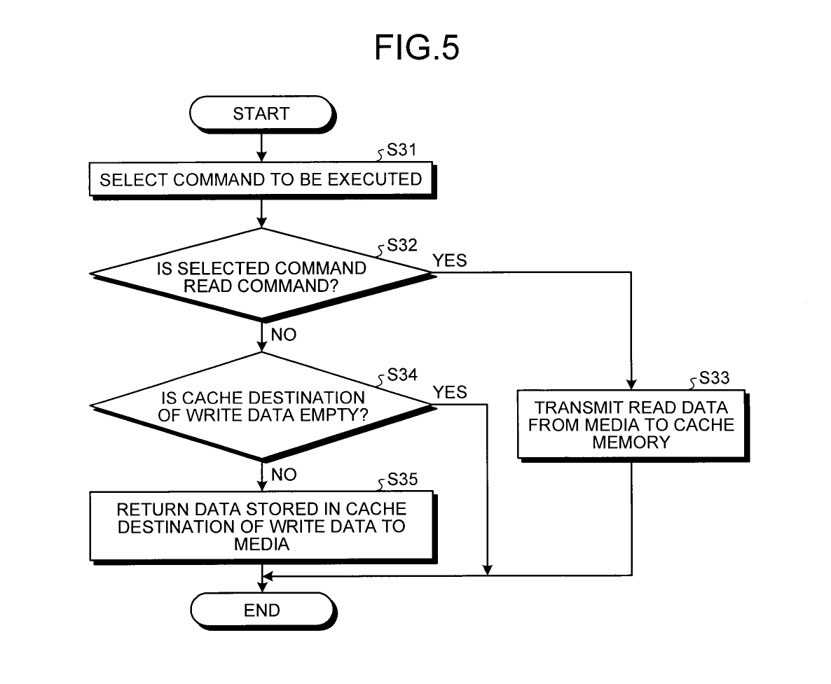

FIG. 5 is a flowchart illustrating the preparation processing. As illustrated in the figure, the NCQ processing unit 22 first selects one command to be executed by referring to the queue 11 (step S31). Then, the CPU 20 determines whether the selected command is the read command (step S32). When the selected command is the read command (Yes in step S32), the CPU 20 accesses the media 2 according to a predetermined read sequence to transmit read out data from the media 2 to the cache memory 3 (step S33). Meanwhile, when the selected command is the write command (No in step S32), the CPU 20 determines whether an area to cache the write data is empty in the cache memory 3 (step S34). When the area to cache the write data is not empty (No in step S34), the CPU 20 extracts data cached in the area to the media 2 in order to empty the area to cache the write data (step S35). When the area to cache the write data is empty (Yes in step S34), the preparation processing is completed after the processing of step S33 or the processing of step S35.

The SATA controller 10 can receive a new command from the host 200 during the period between the timer 12 is started and the timer 12 then times out. After the processing of step S16, the SATA controller 10 determines whether or not the new command has been received (step S17). When the SATA controller 10 has not received the new command (No in step S17), the SATA controller 10 determines whether the timer 12 has timed out (step S18). When the timer 12 has not timed out (No in step S18), the SATA controller 10 executes the determination processing of step S17 again. When the SATA controller 10 receives the new command (Yes in step S17), the SATA controller 10 stores the received command in the queue 11 (step S19) and notifies the host 200 of the completion of receiving the command (step S20). Then, the timer setting unit 21 sets a predetermined value in the timer 12 again (step S21) to restart (reset) the timer 12 (step S22). After the processing of step S22, the SATA controller 10 executes the determination processing of step S17 again.

Note that the determination processing of step S17 can be executed not after the processing of step S16 but during the processing of step S16.

When the timer 12 has timed out (Yes in step S18), the SATA controller 10 notifies the host 200 of the start of data transmission (step S23). Then, data transmission between the host 200 and the cache memory 3 is executed (step S24). Further, in write processing, the write data transmitted from the host 200 is stored in the cache memory 3 in the processing of step S24. In read processing, the write data prepared in the cache memory 3 is transmitted to the host 200.

After the processing of step S24, the SATA controller 10 notifies the host 200 of the completion of transmitting the data (step S25) and deletes a command in which data transmission is completed from the queue 11 (step S26). In addition, the SATA controller 10 determines whether the command remains in the queue 11 (step S27). When the command remains in the queue 11 (Yes in step S27), the processing of step S14 is executed. When the command does not remain in the queue 11 (No in step S27), the processing of step S11 is executed.

As described above, according to the first embodiment of the present invention, since the storage device 100 is configured so as to delay a second timing at which the data transmission processing for the command selected by the NCQ processing unit 22 is started based on a first timing at which the command receiving processing has been most recently executed, command queuing can be implemented based on the NCQ function even in a communication with the host 200 in which an issuing interval of the commands is large by delaying the second timing by an appropriate time. By implementing the command queuing based on the NCQ function, efficiency in data transmission between the host 200 and the storage device 100 can be improved.

Although it has been described that the timer setting unit 21 sets a value whenever the timer 12 is started, the value of the timer 12 can be set only once at the beginning.

Further, the setting value of the timer 12 is sent from the host 200 to the SSD 100, and the timer setting unit 21 can be configured to set the setting value sent from the host 200 in the timer 12. As a result, the host 200 can change a period in which the SSD 100 can continuously receive the command at its command issuing interval.

Further, once the execution of the command is completed, the timer 12 can be configured not to be restarted until the command stored in the queue 11 is removed.

Further, the timer setting unit 21 can be configured to determine a type of the command selected by the NCQ processing unit 22 and do or do not the setting the timer value and the resetting the timer 12 depending on a determination result. For example, the timer setting unit 21 can be configured to set the timer value and reset the timer 12 only when the read command is selected. In addition, the timer setting unit 21 can be configured to set the timer value and reset the timer 12 only when the write command is selected.

In the first embodiment, the setting value of the timer is a fixed value. In this regard, according to the second embodiment, the setting value of the timer is dynamically determined in the storage device. Further, an SSD adopting the storage device of the second embodiment is the same as that of the first embodiment except for a functional configuration of the CPU. Therefore, in the following description, constituent elements other than the functional configuration unit of the CPU will be referred to as the same names and reference numerals as those of the first embodiment, and description of such elements will not be repeated.

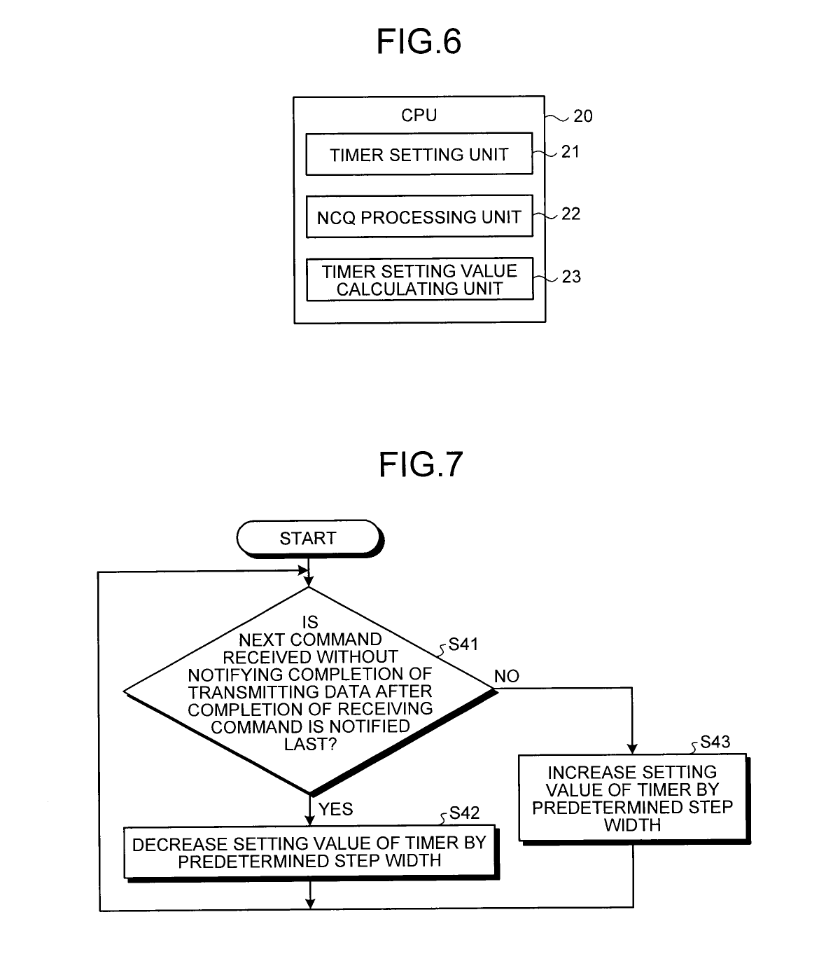

FIG. 6 is a diagram illustrating a function of the CPU of the second embodiment. As illustrated in the figure, a CPU 20 includes a timer setting unit 21, an NCQ processing unit 22 and a timer setting value calculating unit (adjusting unit) 23. The timer setting value calculating unit 23 calculates a setting value of a timer 12 based on a communication state of a SATA I/F 300.

FIG. 7 is a flowchart illustrating an operation of the timer setting value calculating unit 23. Further, the timer setting value calculating unit 23 stores a time when completion of receiving a command is notified to the host 200 (that is, for example, a time when step S13 and step S20 are executed) and a time when a next command is received (that is, for example, a time when Yes is determined in the determination processing of step S17) therein. The timer setting value calculating unit 23 executes an operation described below based on the time stored therein.

The timer setting value calculating unit 23 does not notify the data transmission completion (step S25) and determines whether the next command is received (step S41) after last notification of the command receiving completion. When the data transmission completion is not notified but the next command is received after the last notification of the command receiving completion (Yes in step S41), that is, when the command transmission phase is continuously executed, the timer setting value calculating unit 23 reduces a setting value most recently set in the timer 12 by a predetermined step width (step S42). When the data transmission completion is notified after the last notification of the command receiving completion (No in step S41) but the next command is not received, that is, when the data transmission phase is not continuously executed, the timer setting value calculating unit 23 increases the setting value of the timer 12 by a predetermined step width (step S43). After the processing of step S42 or the processing of step S43, the timer setting value calculating unit 23 executes the judgment processing of step S41 again. Although an execution cycle of the determination processing of step S41 is arbitrary, the judgment processing can be executed, for example, at a timing at which a start of the data transmission is notified (step S23).

The setting value of the timer 12 is converged to a value allowing the fastest notification of the start of the data transmission within a range so as not to hinder the queuing of the command from the host 200 by the above operation.

As such, according to the second embodiment of the present invention, since the storage device 100 adjusts the setting value of the timer 12 based on whether the command receiving processing for the newly received command is executed between the first timing and the second timing, command queuing is implemented based on the NCQ function regardless of the interval in which the host 200 can continuously issue the command. As a result, the efficiency of the data transmission is improved.

Further, the storage device 100 decreases the setting value of the timer 12 when the command receiving processing for the newly received command is executed between the first timing and the second timing. The storage device 100 increases the setting value of the timer 12 when the command receiving processing for the newly received command is not executed between the first timing and the second timing. As a result, the command queuing is implemented based on the NCQ function regardless of the interval in which the host 200 can continuously issue the command.

In addition, the timer setting value calculating unit 23 can store the setting value of the timer 12 in the media 2. As a result, although a power supply of the storage device 100 is turned off, the setting value of the timer 12 can be used when the storage device is started in next time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a queue;
an interface unit configured to exclusively execute command receiving processing of storing commands from a host in the queue and data transmission processing with the host;
a selection unit configured to select one command from the commands stored in the queue; and
a delay unit configured to delay a second timing at which data transmission processing for the selected command is started based on a first timing at which the command receiving processing is executed last,
wherein the interface unit starts the data transmission processing for the selected command at the second timing when a new command is not received between the first timing and the second timing, and executes command receiving processing for the new command when the new command is received between the first timing and the second timing.

2. The storage device according to claim 1, wherein
the interface unit receives a time difference setting value from the host, and
the delay unit sets a timing, at which time is elapsed from the first timing by the received time difference setting value, as the second timing.

3. The storage device according to claim 1, wherein
the delay unit sets a timing, at which time is elapsed from the first timing by a time difference setting value, as the second timing, and
the storage device further includes an adjusting unit configured to adjust the time difference setting value based on whether the command receiving processing for the newly received command is executed between the first timing and the second timing.

4. The storage device according to claim 3, wherein the adjusting unit decreases the time difference setting value when the command receiving processing for the newly received command is executed between the first timing and the second timing and increases the time difference setting value when the command receiving processing for the newly received command is not executed between the first timing and the second timing.

5. The storage device according to claim 1, wherein the delay unit includes a timer and a setting unit configured to set a predetermined time difference setting value to the timer and start the timer at the first timing.

6. The storage device according to claim 5, wherein the setting unit resets the timer when the command receiving processing for the new command is executed.

7. The storage device according to claim 2, wherein the delay unit includes a timer and a setting unit configured to set the time difference setting value to the timer and start the timer at the first timing.

8. The storage device according to claim 7, wherein the setting unit resets the timer when the command receiving processing for the new command is executed.

9. The storage device according to claim 3, wherein the delay unit includes a timer and a setting unit configured to set the time difference setting value to the timer and start the timer at the first timing.

10. The storage device according to claim 1, wherein the delay unit determines a type of the selected command and delays the second timing according to the type of the selected command.

11. A communication method between a host and a storage device, comprising:
by the storage device,
executing command receiving processing of storing commands from the host in a queue;
selecting one command from the commands stored in the queue;
waiting for a new command from the host until a second timing based on a first timing at which the command receiving processing is executed last;
executing command receiving processing for the newly received command when the new command is received before the second timing; and
executing data transmission processing with the host for the selected command when the new command is not received before the second timing.

12. The communication method according to claim 11, further comprising:
by the storage device,
receiving a time difference setting value from the host; and
setting a timing, at which time is elapsed from the first timing by the received time difference setting value, as the second timing.

13. The communication method according to claim 11, further comprising:
by the storage device,
setting a timing, at which time is elapsed from the first timing by a time difference setting value, as the second timing, and
adjusting the time difference setting value based on whether the command receiving processing for the newly received command is executed between the first timing and the second timing.

14. The communication method according to claim 13, wherein the adjusting includes decreasing the time difference setting value when the command receiving processing for the newly received command is executed between the first timing and the second timing and increasing the time difference setting value when the command receiving processing for the newly received command is not executed between the first timing and the second timing.

15. The communication method according to claim 11, wherein the waiting includes setting a predetermined time difference setting value to a timer and starting the timer at the first timing.

16. The communication method according to claim 15, further comprising resetting, by the storage device, the timer when the command receiving processing for the new command is executed.

17. The communication method according to claim 12, wherein the waiting includes setting the timed difference setting value to a timer and starting the timer at the first timing.

18. The communication method according to claim 17, further comprising resetting, by the storage device, the timer when the command receiving processing for the new command is executed.

19. The communication method according to claim 13, wherein the waiting includes setting the timed difference setting value to a timer and starting the timer at the first timing.

20. The communication method according to claim 11, wherein the waiting includes determining a type of the selected command and delaying the second timing according to the type of the selected command.
